(19) United States
(12) Patent Application Publication
(10) Pub. No.: US 2001/0027528 A1
(43) Pub. Date: Oct. 4, 2001

(54) Enhanced pin-based security method and apparatus

(76) Inventors: Roger D. Pirkey, Hudson, FL (US); Luz Maria Camacho, Orlando, FL (US)

Correspondence Address: Pillsbury Winthrop LLP, East Tower, Ninth Floor, 1100 New York Avenue, N.W., Washington, DC, 20005-3918, US

(21) Appl. No.: 09/732,333

(22) Filed: Dec. 6, 2000

Related U.S. Application Data
(60) Provisional application No. 60/183,033, filed on Dec. 8, 1999.

(51) Int. Cl. H04L 9/00; H04L 9/32; G06F 11/30; G06F 12/14

(52) U.S. Cl. 713/202

(57) ABSTRACT

A method and apparatus for reducing fraud is provided. For the purposes of the present invention, the HLR/VLR database is augmented through the use of a profiling database. The profiling database contains several system wide phone number lists. These lists define which numbers cannot be called from mobile sets operating in the wireless network. The lists also define which numbers can be called without using a PIN and which numbers always require a PIN. In addition to the system wide phone number lists, the profiling database stores an individual subscriber profile for each subscriber. Each individual subscriber profile lists the phone numbers that its associated subscriber may dial without using a PIN. When a subscriber dials a number that is not included in their individual subscriber profile, a PIN is required by a validation process. If the PIN is correctly entered, the phone call is allowed by the validation process and the number is added to the subscriber's individual subscriber profile.

### FIELD OF THE INVENTION

The present invention is generally related to networks such as cellular communications networks. More specifically, the present invention includes a PIN validation method and apparatus that simplifies PIN use and increases network security.

### BACKGROUND OF THE INVENTION

The use of personal identification numbers, or PINs, is a standard method for validating users in many environments. This is especially apparent to users of automated teller machines (ATMs) where PIN validation has been used with great success for a number of years. This success is attributable to several features of these networks. One of these features is the fact that most ATM users perform ATM transactions on a daily or less frequent basis. This avoids the type of frustration that might occur if ATM users had to enter their PIN codes with greater frequency.

The success of PIN validation in ATM networks is also attributable to the fact that ATM networks take great care to encrypt all of their communications. This means that PINs are never transmitted “in the clear” and greatly reduces the chances that PINs will be compromised or stolen during transmission.

The factors that contribute to the success of PIN validation in ATM networks are not present in all network types. Consider, for example, the case of cellular networks. A typical cell phone user may place many calls each day. For these users, repeatedly entering their PIN codes may become quite tiresome. More serious, however, is the fact that many cellular networks provide little or no data encryption. This means that PINs may be transmitted in the clear where they are subject to compromise. The problem of PIN compromise is exacerbated by the frequency of PIN validation in cellular networks. Each validation provides a new chance for a PIN to be stolen.

Based on the foregoing, it's easy to appreciate that there are disadvantages associated with PIN validation in cellular networks. Unfortunately, experience has shown that alternatives to PIN validation tend to have their own disadvantages. This is illustrated by the use of authentication. Authentication relies on cryptographic keys that are kept secret and known only to the handset and the service provider. These keys are used to calculate responses to challenges that are issued in conjunction with registration, call origination, call termination, or feature requests. Challenges may be issued by either the handset or network to validate the identity of the other.

When used in cellular networks, authentication can be a highly effective method for improving network security. Unfortunately, the use of authentication requires new handset technology. This means that existing handsets must be replaced or upgraded. Furthermore, a significant fraction of handsets must be replaced or upgraded in order for authentication to be effective. For this reason, authentication may be too expensive for many cellular networks.

RF fingerprinting is another method designed to improve security in cellular networks. Networks that use RF fingerprinting track the radio frequency characteristics that are unique to each handset. This allows these networks to detect when a handset has been cloned or fraudulently copied. Like authentication, RF fingerprinting tends to be expensive to implement. RF fingerprinting also requires cooperation between roaming partners to reach peak effectiveness.

Profiling is another method designed to improve security in cellular networks. Profiling systems process call detail records (CDRs) in near real-time to identify potentially fraudulent activities and present them to a fraud analyst for verification and resolution. Profiling is a people-intensive approach, sometimes requiring service provider personnel from multiple departments to respond to fraud.

Another disadvantage of profiling is that it operates after fraud has already occurred and does not prevent fraud recurrence. It's also very customer intrusive. In most cases, the customer must be contacted by a customer representative in order for action to be implemented.

Still another method for reducing the occurrence of fraud is the use of Roamer Verification with Reinstatement (RVR). RVR allows a roaming subscriber to receive service in a visited system. As a subscriber roams outside of their home service area they are normally prevented from receiving service. To enable roaming service, they are required to contact their home service provider to verify their identity. The home carrier then contacts the roaming service provider to reinstate service for the subscriber.

RVR is another people-intensive process. Customer service centers must be staffed to handle a given volume of RVR customers. It also lacks quick response since it is not automatic, requiring customer-to-carrier interaction, possibly followed by a carrier-to-carrier interaction.

Based on the foregoing, it is easy to conclude that PIN validation is still an important security method for cellular and similar networks. It's also easy to conclude that a need exists for methods that decrease the susceptibility of PIN transmission to compromise in networks of this type. A need also exists for methods that reduce the frequency with which users are required to enter their PIN codes. These needs apply not just to cellular networks, but to many networks that operate without the benefit of highly secure transmission. The same methods are also applicable to many environments where repeated PIN entry detracts from user satisfaction.

### SUMMARY OF THE INVENTION

An object of the invention is to overcome the above-described problems of the prior art and others.

Another object of the present invention is to provide a method and apparatus for effectively reducing fraud.

Another object of the present invention is to provide a method and apparatus for reducing fraud that minimizes the use of PIN codes.

Another object of the present invention is to provide a method and apparatus for reducing fraud that reduces inconvenience to subscribers.

Another object of the present invention is to provide a method and apparatus for reducing fraud that protects the cellular network from unauthorized access.

Another object of the present invention is to provide a method and apparatus for reducing fraud that is relatively inexpensive to implement.

Another object of the present invention is to provide a method and apparatus for reducing fraud that is capable of being deployed in a wide range of different wired and wireless networks.

Another object of the present invention is provide a method and apparatus for introducing additional services to wireless users, such as limited calling phones, teen lines and mobile phones that can be used by corporations to limit the numbers that are called by employees, enhancing services provided to wireless users.

These and other objects of the invention are achieved by a method and apparatus for reducing fraud in which HLR/VLR services are augmented through the use of a novel validation process and profiling database. The profiling database contains several system wide phone number lists. These lists define which numbers cannot be called from mobile sets operating in the wireless network. The lists also define which numbers can be called without using a PIN and which numbers always require a PIN. In addition to the system wide phone number lists, the profiling database stores an individual subscriber profile for each subscriber. Each individual subscriber profile lists the phone numbers that its associated subscriber may dial without using a PIN. When a subscriber dials a number that is not included in their individual subscriber profile, a PIN is required by the validation process. If the PIN is correctly entered, the phone call is allowed and the number is added to the subscriber's individual subscriber profile by the validation process.

These and other objects and advantages of the invention will be set forth, in part, in the description that follows and, in part, will be understood by those skilled in the art from the description herein. The objects and advantages of the invention will be realized and attained by means of the elements and combinations particularly pointed out in the appended claims and equivalents.

### BRIEF DESCRIPTION OF THE DRAWINGS

The accompanying drawings, which are incorporated in and constitute a part of this specification, illustrate several embodiments of the invention and, together with the description, serve to explain the principles of the invention.

FIG. 1 is a block diagram of a GSM type cellular network shown as an exemplary environment for an embodiment of the present invention.

FIG. 2 is a block diagram of a host computer system shown as an exemplary environment for an embodiment of the present invention.

FIG. 3 is a flowchart showing the steps associated with an embodiment of the fraud prevention method of the present invention.

### DETAILED DESCRIPTION OF THE PREFERRED EMBODIMENTS

Reference will now by made in detail to preferred embodiments of the invention, examples of which are illustrated in the accompanying drawings. Wherever convenient, the same reference numbers will be used throughout the drawings to refer to the same or like parts.

### Environment

In FIG. 1, a GSM cellular network 100 is shown as a representative environment for the present invention. Network 100 includes a series of mobile stations, of which mobile stations 102a through 102c are representative. Mobile stations 102 are intended to be representative of a wide range of GSM compatible devices or handsets.

Each mobile station 102 consists of a GSM terminal and a smart card. The smart card is called a Subscriber Identity Module or SIM. The SIM provides personal mobility, so that the user can have access to subscribed services irrespective of the specific GSM terminal. By inserting the SIM card into another GSM terminal, the user is able to make and receive calls at that terminal and receive other subscribed services. Alternately, mobile stations 102 may be analog phones that use MIN/ESN.

Each GSM terminal is uniquely identified by an International Mobile Equipment Identity (IMEI). The SIM card contains an International Mobile Subscriber Identity (IMSI) used to identify the subscriber to the system, a secret key for authentication, and other information. The IMEI and the IMSI are independent, thereby allowing personal mobility. The SIM card may be protected against unauthorized use by a password or personal identity number.

Network 100 also includes a series of base station transceivers, of which base stations transceivers 104a and 104b are representative. Base station transceivers 104, also known as BSTs, provide the radio frequency link between mobile stations 102 and network 100. Each base station transceiver 104 is responsible for a discrete physical area known as a cell.

Base station transceivers 104 are connected with base station controller (BSC) 106. Base station controller 106 controls base station transceivers 104. Network 100 may include any number of base station controllers 106, each controlling a group of one or more base station transceivers 104.

Base station controller 106 is connected to mobile services switching center 108. Mobile services switching (MSC) center 108 acts like a normal switching node within a telephone network. For example, as shown in FIG. 1, mobile services switching center 108 is connected to public switched telephone network (PSTN) 110, which in turn, provides connection to telephone 112. It should be appreciated that the use of PSTN is intended to be representative. Other network types such as ISDN may also be used. Mobile services switching center 108 also provides all the functionality needed to handle mobile subscribers, such as registration, authentication, location updating, handovers, and call routing.

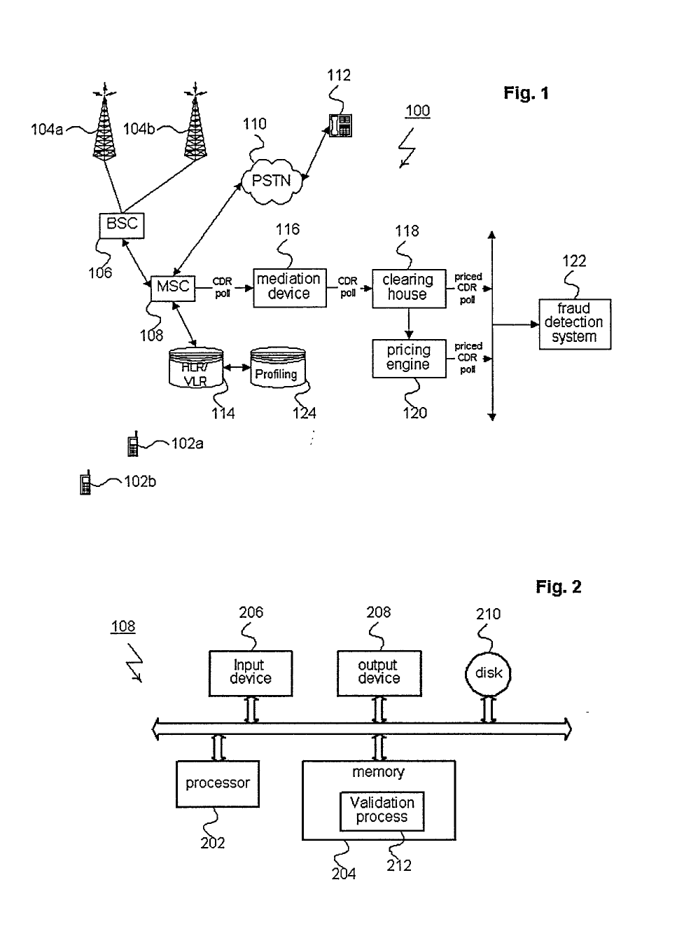

FIG. 2 shows mobile services switching center 108 in more detail. As shown, mobile services switching center 108 includes all of the components of a general purpose computing system including a processor, or processors 202, and a memory 204. An input device 206 and an output device 208 are connected to processor 202 and memory 204. Input device 206 and output device 208 represent a wide range of varying I/O devices such as disk drives, keyboards, modems, network adapters, printers and displays. Mobile services switching center 108 may also includes a disk drive 120 of any suitable disk drive type (equivalently, disk drive 120 may be any non-volatile mass storage system such as “flash” memory). Further descriptions of these elements are not necessary for an understanding of the present invention and it should be apparent to those of skill in the computer software and hardware arts that many further alternative embodiments of mobile services switching center 108 are possible, in keeping with the principles of the invention that are fully described herein.

Referring again to FIG. 1, mobile services switching center 108 is also connected to HLR/VLR 114. HLR/VLR 114 includes two databases. These are known as the home location register (HLR) and the Visitor Location Register (VLR). Mobile services switching center 108 uses the HLR and VLR to provide the call routing and roaming capabilities of GSM. The HLR contains all the administrative information of each subscriber registered in the corresponding GSM network, along with the current location of the mobile station. The location of the mobile station is typically in the form of the signaling address of the VLR associated with the mobile station. There is logically one HLR per GSM network, although it may be implemented as a distributed database.

The visitor location register (VLR) contains selected administrative information from the HLR, necessary for call control and provision of the subscribed services, for each mobile station currently located in the geographical area controlled by the VLR. Although the VLR may be implemented as an independent unit, it is typically implemented together with mobile services switching center 108. This means that the geographical area controlled by mobile services switching center 108 corresponds to that controlled by the VLR. This simplifies the signaling required. In general it should be noted that mobile services switching center 108 contains information about particular mobile station 102. This information is stored in the HLR and VLR.

Mobile services switching center 108 also works with an equipment identity register (EIR) and authentication center (AuC) (EIR and AuC not shown). The EIR is a database that contains a list of all valid mobile stations 102. Within the EIR, each valid mobile station 102 is identified by its International Mobile Equipment Identity (IMEI). An IMEI is marked as invalid if it has been reported stolen or is not type approved. The AuC is a protected database that stores a copy of a secret key stored in each subscriber's SIM card, which is used for authentication and encryption over the radio channel.

Mobile services switching center 108 is also connected to mediation service 116. Mediation service 116 is connected, in sequence, to clearing house 118 and pricing engine 120. Clearing house 118 and pricing engine 120 are both connected to fraud detection engine 122. Mediation service 116 routes or acts on information and/or Call Detail Records (CDRs) passing between network elements and network operations. Clearing House 118 is a record exchange system that sends call detail records (CDRs) from an outside carrier to the home carrier in near real-time. Rating Engine 120 is a set of functions that includes all the resources consumed, the facilities used to collect accounting data, the facilities used to set billing parameters for the services used by customers, maintenance of the data bases used for billing purposes, and the preparation of resource usage and billing reports. Fraud Detection System 122 is a system that processes subscriber information and builds a behavior profile for each individual using relevant information or monitors subscriber activity against known indicators of fraud for timely identification of fraud behavior.

### Overview

In accordance with an aspect of the present invention, a validation process in memory 204 can be executed by processor 202 in Mobile services switching center 108. The validation process (designated 212 in FIG. 2) works in combination with the profiling database 124 shown in FIG. 1. The combination of validation process 212 and profiling database 124 function as an extension to the services provided by the HLR portion of HLR/VLR 114, which services should be well understood by those of skill in the art.

Profiling database 124 includes several different types of information. This information includes a per-subscriber list of allowed phone numbers. These per-subscribers lists are known as individual subscriber profiles. Each number in a subscriber's individual subscriber profile is a number that the subscriber is allowed to call without using a PIN.

The information included in the profiling database may also include one or more system-wide phone number lists. In a typical case, these lists include an Always require PIN list, an Always allow list and an Always deny list. Each number in the Always require PIN list is a number for which a PIN is always required. This requirement applies regardless of the identity of the subscriber placing the call. Each number in the Always allow list is a number that never requires a PIN to dial. These number typically include emergency and convenience numbers such as 911 or 0. Each number in the Always deny list is a number that cannot be dialed. These numbers typically correspond with mobile stations 102 that have been associated with fraudulent use.

Numbers in the system-wide phone number lists (i.e, Always require PIN list, Always allow list, Always deny list) take precedence over the individual subscriber profiles. For this reason, the system-wide phone number lists provide the final determination as to whether a number can be dialed and whether the number requires a PIN.

It should be noted that numbers in the system wide phone number lists may be entered using wildcard or other regular expression or pattern matching technology. For example, profiling database 124 can be configured so that all calls to 900 numbers require PIN entry. This same idea can be used to require PIN entry for all international calls or to reject all calls to a specified country.

### Method for Reducing Fraud

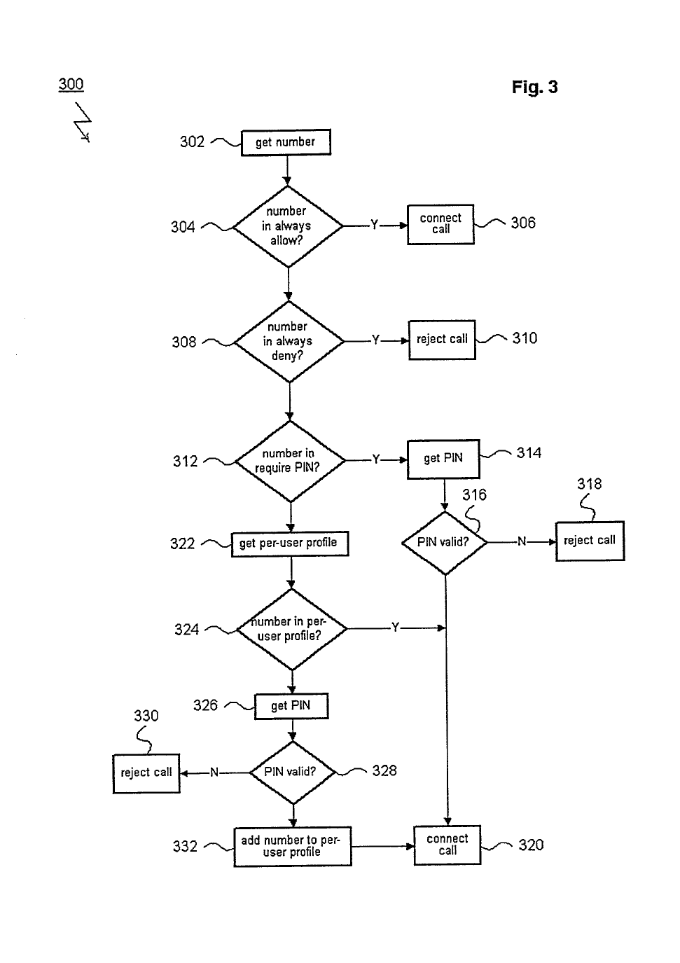

In FIG. 3, an embodiment of the method for reducing fraud is shown and generally designated 300. Validation process 212 includes functionality for invoking Method 300 to respond to a call originated by a subscriber using one of mobile stations 102. Validation process 212 begins Method 300 by retrieving the number being dialed.

In step 304, validation process 212 determines if the number being called is present in the always allow list of profiling database 124. If the number being called is present, validation process 212 continues execution of Method 300 at step 306 by allowing the call to complete.

In the alternative (i.e., where the number being called is not present in the always allow list) validation process 212 continues execution of method 300 at step 308. In step 308, validation process 212 determines if the number being called is present in the always deny list of profiling database 124. If the number being called is present, validation process 212 continues execution of Method 300 at step 310 by rejecting the call.

If the number being dialed is not in the always allow list or the always deny list, method 300 continues at step 312. In step 312, validation process 212 determines if the number being called is present in the always require PIN list of profiling database 124. If the number being called is present, validation process 212 continues execution of Method 300 at step 314 by retrieving a PIN from the subscriber making the call. Subsequently, in step 316, validation process 212 determines (by consulting the HLR portion of HLR/VLR 114) if the PIN supplied by the subscriber is valid. If the supplied PIN is invalid, validation process 212 rejects the call at step 318. In the alternative (i.e., where the supplied PIN is valid) validation process 212 continues method 300 at step 320 by accepting the call.

Step 322 is reached when validation process 212 determines that the number being dialed is not in any of the system-wide phone number lists (i.e., Always require PIN list, Always allow list, Always deny list). In step 322, validation process 212 retrieves the individual subscriber profile associated with the subscriber placing the call.

In step 324, validation process 212 consults the just-retrieved individual subscriber profile to determine if the number being called is present. If the number being called is included in the subscriber's individual subscriber profile, validation process 212 continues Method 300 at step 320 and allows the call to complete. In the alternative (i.e., where the number being called is not included in the subscriber's individual subscriber profile), validation process 212 continues execution of Method 300 at step 326 by retrieving a PIN from the subscriber making the call. Subsequently, in step 328, validation process 212 determines (by consulting the HLR portion of HLR/VLR 114) if the PIN supplied by the subscriber is valid. If the supplied PIN is invalid, validation process 212 rejects the call at step 330. In the alternative (i.e., where the supplied PIN is valid) validation process 212 continues method 300 at step 332 by adding the number being dialed to the subscriber's individual subscriber profile. Validation process 212 then continues method 300 at step 320 by accepting the call.

A technical report setting forth a comparative analysis of the fraud prevention mechanism of the present invention against conventional approaches is attached as an Appendix to this application, and its contents are fully incorporated herein by reference.

In general, it should be appreciated that the methods described in the preceding paragraphs are not intended to be limited to cellular networks. In fact, there is a range of environments where the same method may be successfully used. These include not only mobile phones and cell phones but also calling card profiles, limited calling plans and other appropriate business practices.

Other embodiments will be apparent to those skilled in the art from consideration of the specification and practice of the invention disclosed herein. It is intended that the specification and examples be considered as exemplary only, with a true scope of the invention being indicated by the following claims and equivalents.

What is claimed is:

1. A method for providing access to resources with the use of personal identification numbers, comprising the steps of:
receiving a request from a subscriber to access a resource;
providing access if the resource is included in a list associated with the subscriber;
requiring the subscriber to input a personal identification number if the resource is not included in the list associated with the subscriber; and
providing access if the subscriber inputs the correct personal identification number.

2. A method as recited in claim 1 further comprising the step of adding the resource to the list associated with the subscriber if the subscriber inputs the correct personal identification number.

3. A method as recited in claim 1 further comprising the step of providing access if the resource is included in an always allow list.

4. A method as recited in claim 1 further comprising the step of denying access if the resource is included in an always deny list.

5. A method as recited in claim 1 further comprising the step of requiring the subscriber to input a personal identification number if the resource is included in an always require PIN list.

6. A method as recited in claim 1 wherein the resource is a telephone connection to a destination phone number.

7. A method as recited in claim 1 wherein the request is received from a mobile or cellular phone.

8. A method as recited in claim 1 wherein the subscriber requests the resource using one of a credit, debit, and calling card.

9. A method for providing access to resources with the use of personal identification numbers, comprising the steps of:
maintaining a list of resources accessed by a user;
allowing the user to access resources included in the list;
requiring the user to enter a personal identification number to access a further resource not included in the list; and
adding the further resource that the user accesses using the personal identification number to the list.

10. A method as recited in claim 9 further comprising the step of allowing the user to access a still further resource if the still further resource is included in an always allow list.

11. A method as recited in claim 9 further comprising the step of denying the user access to a still further resource if the still further resource is included in an always deny list.

12. A method as recited in claim 9 further comprising the step of requiring the user to input a personal identification number to access a still further resource included in an always require PIN list.

13. A method as recited in claim 9 wherein the resources are telephone connections to destination phone numbers.

14. A method as recited in claim 9 wherein the user requests resources using a mobile or cellular phone.

15. A method as recited in claim 9 wherein the user requests resources using one of a credit, debit, and calling card.

16. An apparatus for providing access to resources with the use of personal identification numbers, comprising:
means for receiving a request from a subscriber to access a resource;
means for providing access if the resource is included in a list associated with the subscriber;
means for requiring the subscriber to input a personal identification number if the resource is not included in the list associated with the subscriber; and
means for providing access if the subscriber inputs the correct personal identification number.

17. An apparatus as recited in claim 16 further comprising means for adding the resource to the list associated with the subscriber if the subscriber inputs the correct personal identification number.

18. An apparatus as recited in claim 16 further comprising means for providing access if the resource is included in an always allow list.

19. An apparatus as recited in claim 16 further comprising means for denying access if the resource is included in an always deny list.

20. An apparatus as recited in claim 16 further comprising means for requiring the subscriber to input a personal identification number if the resource is included in an always require PIN list.

21. An apparatus as recited in claim 16 wherein the resource is a telephone connection to a destination phone number.

22. An apparatus as recited in claim 16 wherein the request is received from a mobile or cellular phone.

23. An apparatus as recited in claim 16 wherein the subscriber requests the resource using one of a credit, debit, and calling card.

24. An apparatus for providing access to resources with the use of personal identification numbers, comprising:
means for maintaining a list of resources accessed by a user;
means for allowing the user to access resources included in the list;
means for requiring the user to enter a personal identification number to access a further resource not included in the list; and
means for adding the further resource that the user accesses using the personal identification number to the list.

25. An apparatus as recited in claim 24 further comprising means for allowing the user to access a still further resource if the still further resource is included in an always allow list.

26. An apparatus as recited in claim 24 further comprising means for denying the user access to a still further resource if the still further resource is included in an always deny list.

27. An apparatus as recited in claim 24 further comprising means for requiring the user to input a personal identification number to access a still further resource included in an always require PIN list.

28. An apparatus as recited in claim 24 wherein the resources are telephone connections to destination phone numbers.

29. An apparatus as recited in claim 24 wherein the user requests resources using a mobile or cellular phone.

30. An apparatus as recited in claim 24 wherein the user requests resources using one of a credit, debit, and calling card.
